(19) United States
(12) Patent Application Publication
(10) Pub. No.: US 2007/0246104 A1
(43) Pub. Date: Oct. 25, 2007

(54) Pressure controller of filter of pneumatic cylinder

(76) Inventor: Tsai-Chao Wu, Taichung City (TW)

Correspondence Address: BROWDY AND NEIMARK, P.L.L.C.;624 NINTH STREET, NW, SUITE 300, WASHINGTON, DC, 20001-5303, US

(21) Appl. No.: 11/434,265

(22) Filed: May 16, 2006

(30) Foreign Application Priority Data
Apr. 12, 2006 (TW) 95206186

(51) Int. Cl. F16K 37/00

(52) U.S. Cl. 137/553

(57) ABSTRACT

A pressure controller for a filter of a pneumatic cylinder includes a base and a knob. The knob is fitted to a shaft of the base to be moved between an open position, in which the knob is free for rotation and exposes an indication member on the shaft, and a close position, in which the knob is fixed and hide the indication member in the knob.

### BACKGROUND OF THE INVENTION

1. Field of the Invention

The present invention relates generally to a filter of a pneumatic cylinder, and more particularly to a pressure controller of the filter.

2. Description of the Related Art

FIG. 6 shows a conventional pressure controller 80 for a filter 90 of a pneumatic cylinder. The pressure controller 80 includes a base 82 and a knob 84. The base 82 has a shaft 822, and the knob 84 is fitted to the shaft 822 for rotation. The knob 84 has an indication device 842, as shown in FIG. 7, which includes an arrow 844. The knob 84 is turned according to the direction of the arrow 844 to adjust the pressure of the filter 90.

Some filters 90 has the pressure controller 80 mounted on a bottom thereof, as shown in FIG. 8. User is hard to see the indication device 842 of the pressure controller 80. As a result, user may make a mistake in adjustment of the pressure of the filter 90.

### SUMMARY OF THE INVENTION

The primary objective of the present invention is to provide a pressure controller of a filter of a pneumatic cylinder, which has an indication device on a lateral side thereof to be seen easier by user.

According to the objective of the present invention, a pressure controller for a filter of a pneumatic cylinder includes a base and a knob. The base has a main member and a shaft projected from the main member. The knob is connected to the shaft for rotation. The pressure controller further has an indication member on a lateral side thereof.

In the embodiment of the present invention, the indication member is a band-like and colorful sticker stuck on the shaft of the base. The indication member has an arrow to indicate the rotation direction. The knob is fitted to a shaft of the base to be moved between an open position, in which the knob is free for rotation and exposes an indication member on the shaft, and a close position, in which the knob is fixed and hide the indication member in the knob.

Therefore, the indication member only shows up when user wants to adjust the pressure of the filter that provides a convenient operation mode.

### BRIEF DESCRIPTION OF THE DRAWINGS

FIG. 1 is a front view of a preferred embodiment of the present invention mounted on the filter;

FIG. 2 is an exploded view of the preferred embodiment of the present invention;

FIG. 3 is a sectional view of the preferred embodiment of the present invention;

FIG. 4 is a perspective view of the preferred embodiment of the present invention, showing the adjustment device in the open position;

FIG. 5 is a perspective view of the preferred embodiment of the present invention, showing the adjustment device in the close position;

FIG. 6 is a front view of the convention filter with the pressure controller;

FIG. 7 is a top view of the knob of the pressure controller; and

FIG. 8 is a front view of another convention filter with the pressure controller on the bottom thereof.

### DETAILED DESCRIPTION OF THE INVENTION

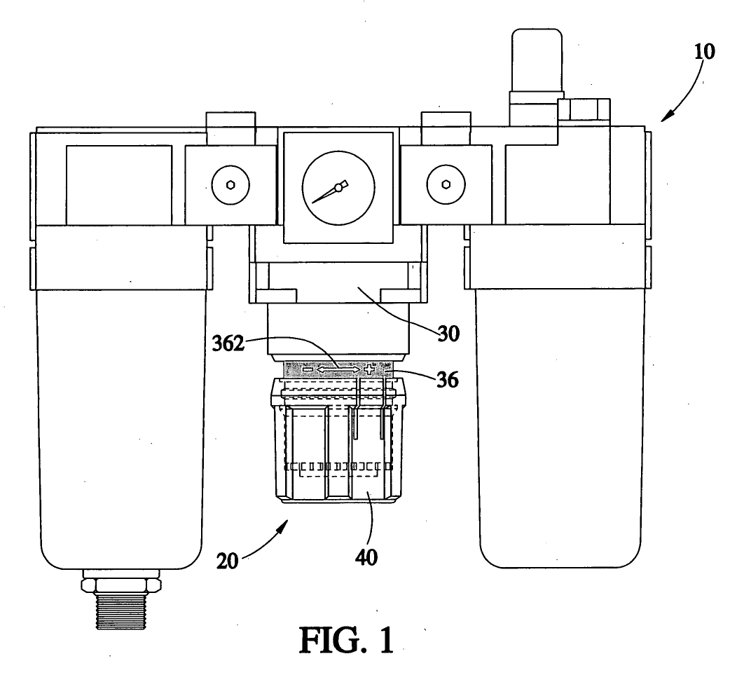

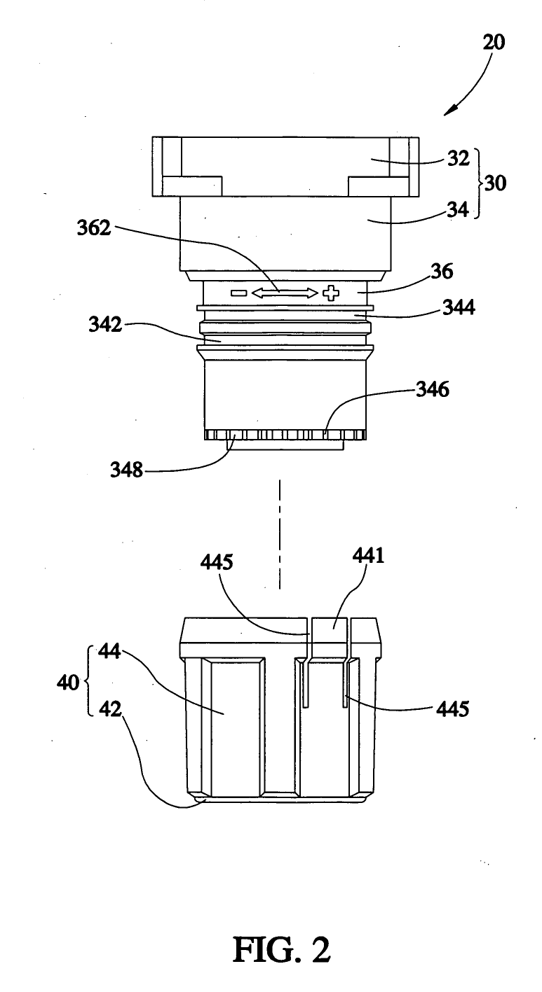

As shown in FIG. 1 and FIG. 2, a pressure controller 20, which is mounted on a filter 10 of a pneumatic cylinder, includes a base 30 and a knob 40.

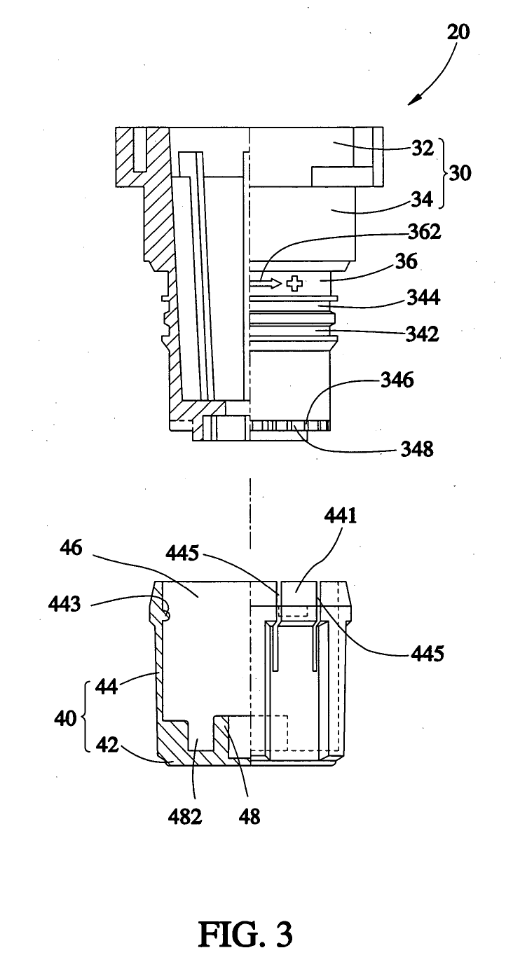

As shown in FIG. 3, the base 30 has a main member 32 and a shaft 34. The main member 32 is connected to the filter 10, and the shaft 34 is projected from the main member 32. The shaft 34 is provided with an indication member 36 on a circumference thereof. In the present invention, the indication member 36 is a band-like sticker with colorful painting thereon stuck on the shaft 34 adjacent to the main member 32. The indication member 36 includes an arrow 362 for indication of the rotation direction. The shaft 34 includes a first annular slot 342 and a second annular slot 344, wherein the second annular slot 344 is under the indication member 36 and the first annular slot 342 is under the second annular slot 344. The shaft 34 has a plurality of positioning plates 346 at a bottom end thereof, which are arranged in a radial pattern with a constant interval therebetween, therefore, positioning slots 348 are formed between the positioning plates 346.

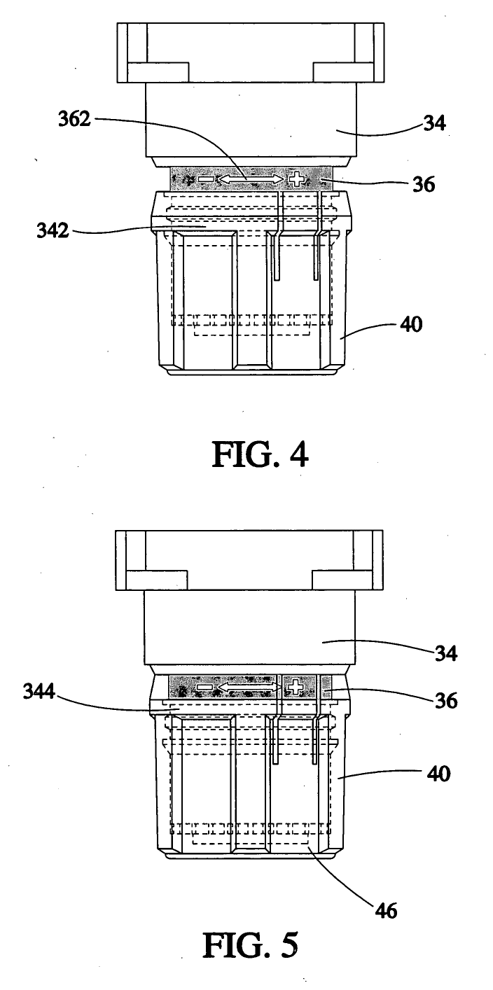

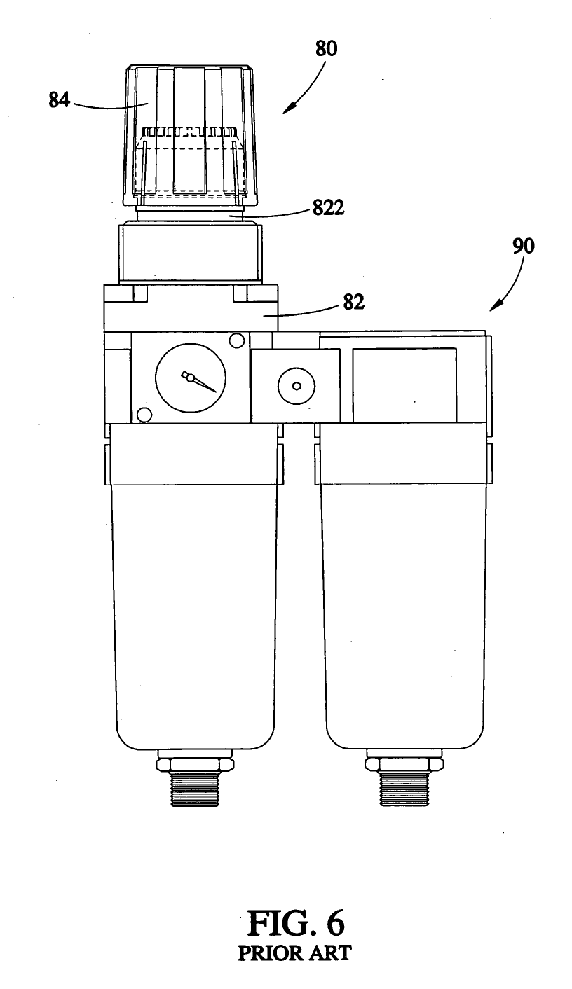

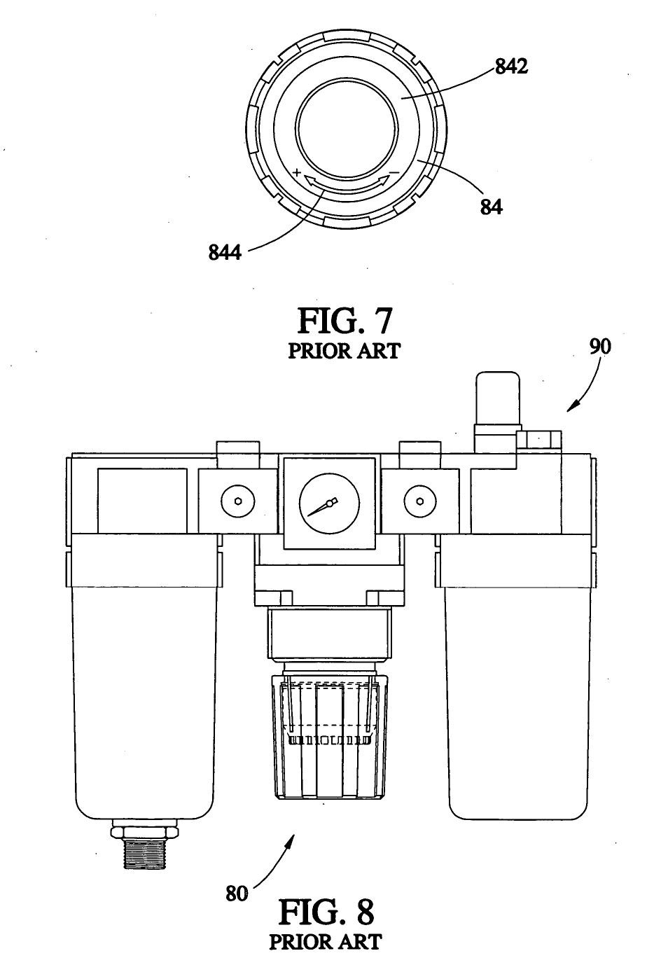

The knob 40 has an end side 42 and a circumference side 44, in which a chamber 46 is formed to be fitted to the shaft 34 of the base 30. The knob 40 has a plurality of ribs 441 and protrusions 443 on interior sides of the ribs 441. The protrusions 443 are engaged with the first annular slot 342 or the second annular slot 344 of the shaft 34. When the protrusions 443 are engaged with the first annular slot 342, as shown in FIG. 4, the knob 40 is in an open position, and when the protrusions 443 are engaged with the second annular slot 344, as shown in FIG. 5, the knob 40 is in a close position. The knob 40 has gaps 445 between the ribs 441 to provide the ribs with flexibility allowing the protrusions 443 shifting between the first annular slot 342 and the second annular slot 344. The knob 40 further has a plurality of positioning plates 48 at a junction of an interior side of the end side 42 and an interior side of the circumference side 44 and positioning slots 482 between the positioning plates 48. When the knob 40 is at the open position, the knob 40 is distal to the main member 32, in which the positioning plates 48 of the knob 40 are separated from the positioning slots 348 of the shaft 34, so that the knob 40 is turned independently relative to the shaft 34, and the indication member 36 is exposed. When the knob 40 is at the close position, the knob 40 is proximal to the main member 32, in which the positioning plates 48 of the knob 40 are engaged with the positioning slots 348 of the shaft 34, so that the knob 40 is no longer turned, and the indication member 36 is hidden by the knob 40.

While user wants to adjust the pressure of the filter 10, he/she has to pull the knob 40 to the open position, as shown in FIG. 4, in which the indication member 36 is exposed to indicate user how to adjust the pressure according to the arrow 362. After that, user may push the knob 40 to the close position, as shown in FIG. 5, in which the knob 40 is fixed to the shaft 34.

In conclusion, the pressure controller 20 of the present invention provides the indication member 36 showing up when user wants to turn the knob 40 and hidden after adjustment.

What is claimed is:

1. A pressure controller for a filter of a pneumatic cylinder, comprising a base, a knob and an indication member, wherein the base has a main member and a shaft projected from the main member, and the knob, which has an end side and a circumference side, is connected to the shaft for rotation, and the indication member is provided at a lateral side of the pressure controller.

2. The pressure controller as defined in claim 1, wherein the indication member is provided at a shaft of the base adjacent to the main member.

3. The pressure controller as defined in claim 1, wherein the indication member includes an arrow to indication a rotation direction of the pressure controller.

4. The pressure controller as defined in claim 1, wherein the indication member has a colorful painting thereon.

5. The pressure controller as defined in claim 1, wherein the indication member is a band-like and colorful sticker stuck on the pressure controller.

6. The pressure controller as defined in claim 1, wherein the knob is move between an open position, in which the knob is rotated freely, and a close position, in which the knob is fixed.

7. The pressure controller as defined in claim 6, wherein the knob and the shaft are provided with positioning plates and positioning slots, whereby the positioning plates is engaged with the positioning slots when the knob is move to the close position, and the positioning plates are separated from the positioning slots when the knob is move to the open position.

8. The pressure controller as defined in claim 6, wherein the shaft has a first slot and a second slot, and the knob has a protrusion, whereby the protrusion of the knob is engaged with the first slot of the shaft when the knob is move to the close position, and the protrusion of the knob is engaged with the second slot of the shaft when the knob is move to the open position.

9. The pressure controller as defined in claim 8, wherein the knob is provided with gaps to provide flexibility to the knob allowing the protrusion of the knob moving between the first slot and the second slot of the shaft.

10. The pressure controller as defined in claim 1, wherein the knob is move between an open position, in which the indication member is exposed, and a close position, in which the indication member is hidden.

11. The pressure controller as defined in claim 10, wherein the knob is distal to the shaft when the knob is move to the open position to expose the indication member, and the knob is proximal to the shaft when the knob is move to the close position to hide the indication member.
